(19) United States
(12) Patent Application Publication
(10) Pub. No.: US 2017/0177964 A1
(43) Pub. Date: Jun. 22, 2017

(54) OPTICAL INSPECTION SYSTEM AND OPTICAL INSPECTION METHOD THEREOF

(71) Applicant: INDUSTRIAL TECHNOLOGY RESEARCH INSTITUTE, Hsinchu (TW)

(72) Inventors: Chi-Lin WU, New Taipei City (TW); Ludovic ANGOT, Hsinchu City (TW); An-Chun LUO, Taichung City (TW)

(73) Assignee: INDUSTRIAL TECHNOLOGY RESEARCH INSTITUTE, Hsinchu (TW)

(21) Appl. No.: 14/974,005

(22) Filed: Dec. 18, 2015

(51) Int. Cl. G06K 9/20; G06T 7/00; G02B 27/14; H04N 5/225; F21V 14/06; F21V 5/00

(52) U.S. Cl. CPC G06K 9/2027; F21V 14/06; F21V 5/008; G02B 27/144; H04N 5/2256; G06T 7/0002

(57) ABSTRACT

According to embodiments of the disclosure, an optical inspection system and an optical inspection method thereof are provided. The optical inspection system may include a lens group, a light source and a lens controlling module. The light source is configured to illuminate an object. The lens group is configured to project the light from the light source as a collimated rectangular shaped light. The lens controlling module is configured to switch the lens group for changing an irradiance of the collimated rectangular shaped light and adjusting an illuminated area of the collimated rectangular shaped light on an object surface of the object.

### TECHNICAL FIELD

The disclosure relates in general to an optical inspection system and an optical inspection method thereof.

### BACKGROUND

Conventional optical inspection system may detect and measure a defect of an object. The optical inspection system includes a light source. In detecting mode, the light source may increase an illumination by increasing current. In measuring mode, the light source may decrease the illumination by reducing current. However, the increasing current causes over-heating and low efficient.

### SUMMARY

According to an embodiment of the disclosure, an optical inspection system is provided. The optical inspection system may include a lens group, a light source and a lens controlling module. The light source is configured to illuminate an object. The lens group is configured to project the light from the light source as a collimated rectangular shaped light. The lens controlling module is configured to switch the lens group for changing an irradiance of the collimated rectangular shaped light and adjusting an illuminated area of the collimated rectangular shaped light on an object surface of the object.

According to another embodiment of the disclosure, an optical inspection method is provided. The optical inspection method may include the following steps. An optical inspection system is provided, wherein the optical inspection system may include a lens group, a light source and a lens controlling module. The light source is configured to illuminate an object. The lens group is configured to project the light from the light source as a collimated rectangular shaped light. The lens controlling module is configured to switch the lens group for changing an irradiance of the collimated rectangular shaped light and adjusting an illuminated area of the collimated rectangular shaped light on an object surface of the object; an object is illuminated with light of the light source; and the lens group is controlled by the lens controlling module to transform the light into a collimated rectangular shaped light and incident the collimated rectangular shaped to an object, wherein an irradiance and an illuminated area on the object surface of the collimated rectangular shaped light is adjusted by the lens controlling module.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1 illustrates a block diagram of an optical inspection system according to an embodiment of the disclosure;

FIG. 2A illustrates a top view of the lens group of FIG. 1;

FIG. 2B illustrates a side view of the second-type light in the second mode of FIG. 2A;

FIG. 3A illustrates a top view of the concave lens of FIG. 2A moving to another position;

FIG. 3B illustrates a side view of the narrow width of the brighter first-type light in the first mode of FIG. 3A;

FIG. 4A illustrates a top view of the lens group according to another embodiment of the disclosure;

FIG. 4B illustrates a top view of the concave lens of FIG. 4A moving to another position;

FIG. 5A illustrates a side view of the lens group according to another embodiment of the disclosure;

FIG. 5B illustrates a side view of the concave lens of FIG. 4A moving to another position;

FIG. 6 illustrates a block diagram of an optical inspection system according to another embodiment of the disclosure;

FIG. 7 illustrates a flow chart of an optical inspection method according to an embodiment of the disclosure; and

FIG. 8 illustrates a diagram of the object of FIG. 3A.

In the following detailed description, for purposes of explanation, numerous details are set forth in order to provide a thorough understanding of the disclosed embodiments. It will be clear, that one or more embodiments may be practiced without these details. In other instances, well-known structures and devices are schematically shown in order to simplify the drawing.

### DETAILED DESCRIPTION

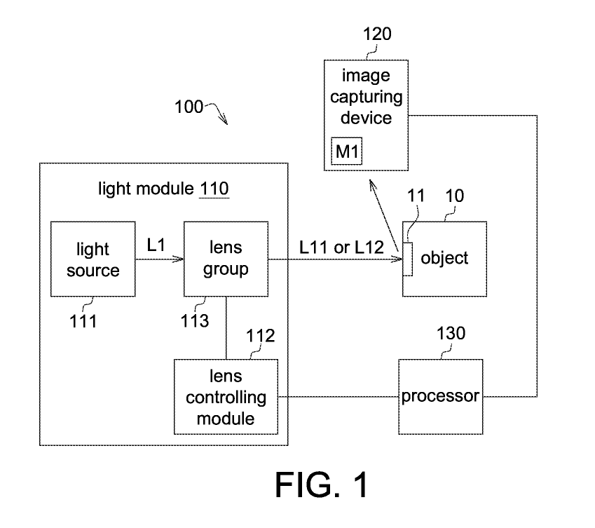

FIG. 1 illustrates a block diagram of an optical inspection system 100 according to an embodiment of the disclosure. The optical inspection system 100 includes a light module 110, an image capturing device 120 and a processor 130.

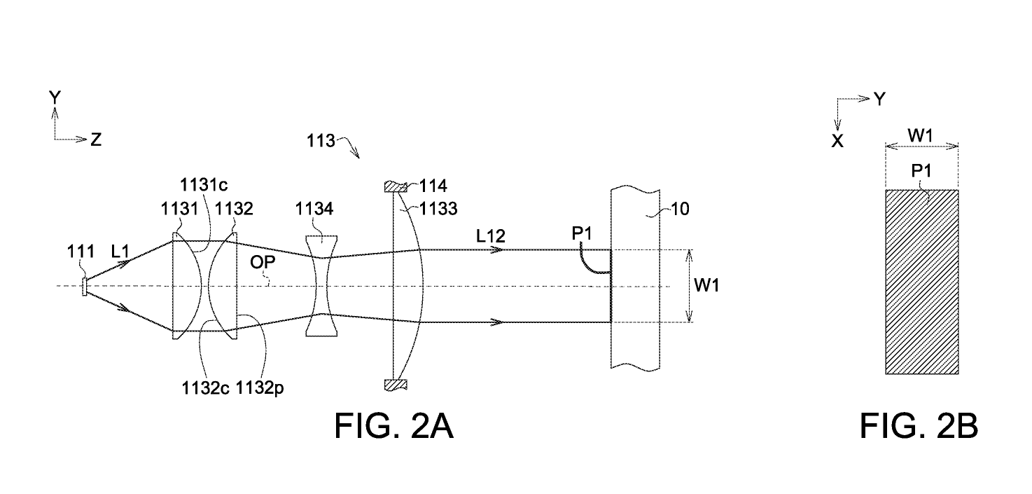

The light module 110 includes a light source 111, a lens controlling module 112, a lens group 113 and a fastener 114 (as illustrated in FIG. 2A). The light source 111 may emit light L1 to an object 10 through the lens group 113. The object 10 is, for example, a printed circuit board (PCB). The lens controlling module 112 is configured to switch the lens group 113 between a first mode and a second mode. In the first mode. After passing through the lens controlling module 112, the light L1 is transformed into a collimated rectangular shaped light and change the irradiance and the illuminated area of the light L1 which is incident to the object 10. The collimated rectangular shaped light is, for example, a first-type light L11 in the first mode and a second-type light L12 in the second mode, wherein the second-type light L12 is different from the first-type light L11.

Because of the first-type light L11 having higher irradiance than the second-type light L12, the first-type light L11 can be used for detecting defect 11 of the object 10 in the first mode. The image M1 captured by the image capturing device 120 using the second-type light L12 in the second mode has higher contrast than the image captured by using the first-type light L11 in the first mode, and thus the second-type light L12 in the second mode can be used for measuring the size of the defect 11.

The image capturing device 120 may capture the image M1 of the object 10 in the first mode. The processor 130 may detect whether the object 10 has a defect 11 from the image M1 in the first mode, and measure a size of the defect 11 in the second mode.

In the present embodiment, the lens group 113 can transform the same light L1 into the first-type light L11 in the first mode or the second-type light L12 in the second mode different from the first-type light L11, and accordingly the number of the light source 111 may be only one.

FIG. 2A illustrates a top view of the lens group 113 of FIG. 1, and FIG. 2B illustrates a side view of the second-type light L12 in the second mode of FIG. 2A.

The lens group 113 includes a first convex lens 1131, a second convex lens 1132, a cylindrical convex lens 1133 and a concave lens 1134 which are arranged sequentially. In the present embodiment, the first convex lens 1131 and the second convex lens 1132 are aspheric condenser lenses.

The first convex lens 1131 may collimate the light L1 from the light source 111. The second convex lens 1132 has a second plane 1132p and a second convex surface 1132c, wherein the second convex surface 1132c faces a first convex surface 1131c of the first convex lens 1131. The concave lens 1134 is disposed between the second convex lens 1132 and the cylindrical convex lens 1133. In addition, the cylindrical convex lens 1133 may be fixed by the fastener 114. The fastener 114 may block spurious light rays. Although not illustrated, the light module 110 further includes a lens tube mount capable of blocking spurious light rays, and the concave lens 1134 is movably disposed within the lens tube mount.

Under the arrangement of the first convex lens 1131, the second convex lens 1132, the cylindrical convex lens 1133 and the concave lens 1134, the light L1 can be transformed into the second-type light L12 in the second mode which is collimated rectangular shaped light.

In addition, the concave lens 1134 may move between the second convex lens 1132 and the cylindrical convex lens 1133 for adjusting the irradiance and a width W1 of an illuminated area P1 of the second-type light L12 in the second mode on the object 10.

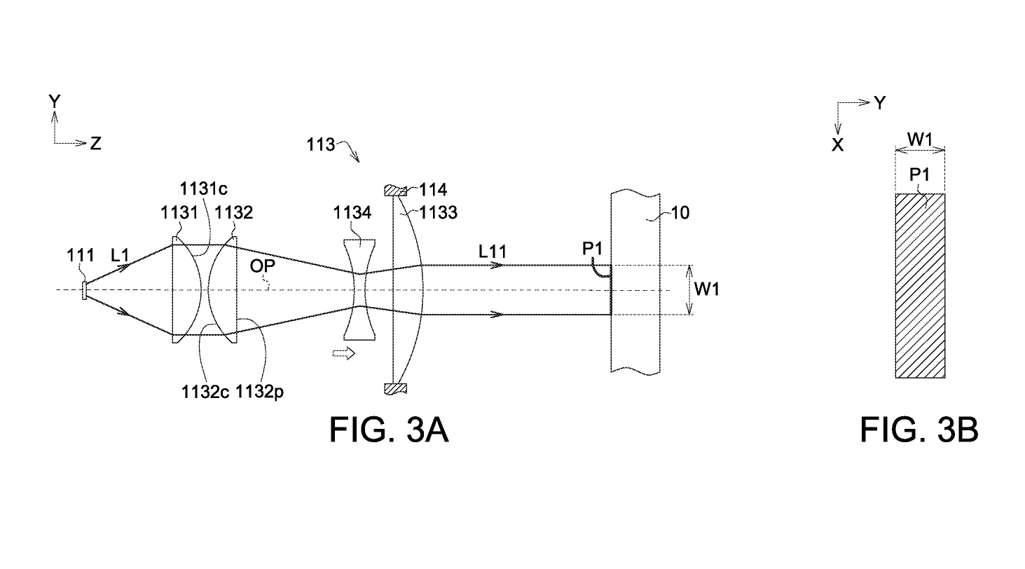

FIG. 3A illustrates a top view of the concave lens 1134 of FIG. 2A moving to another position, and FIG. 3B illustrates a side view of the narrow width of the brighter first-type light L11 in the first mode of FIG. 3A.

The concave lens 1134 is controlled by the lens controlling module 112 to move to any position of an optical axis OP (for example, in Z axis) between the second convex lens 1132 and the cylindrical convex lens 1133 for adjusting the width W1 of the illuminated area P1 of the first-type light L11 in the first mode on the object 10. The lens controlling module 112 is, for example, a mechanism, a motor, etc.

As shown in FIG. 3B, the concave lens 1134 approaches the cylindrical convex lens 1133, and accordingly the width W1 of the illuminated area P1 becomes smaller, but the first-type light L11 in the first mode becomes brighter for detecting the defect of the object 10.

In another embodiment, the concave lens 1134 is, for example, an electrically tunable-focusing lens. Under such design, the lens controlling module 112 may control the index of refraction of the electrically tunable-focusing lens to transform the electrically tunable-focusing lens into a concave lens, as positioned at the position of FIG. 2A or FIG. 3A.

As described above, the lens group 113 may transform the light L1 into the collimated rectangular shaped light and change the irradiance of the collimated rectangular shaped light and the illuminated area of the collimated rectangular shaped light, and accordingly the controls for the irradiance of the light L1 of the light source 111 and current applied to the light source 111 are not necessary.

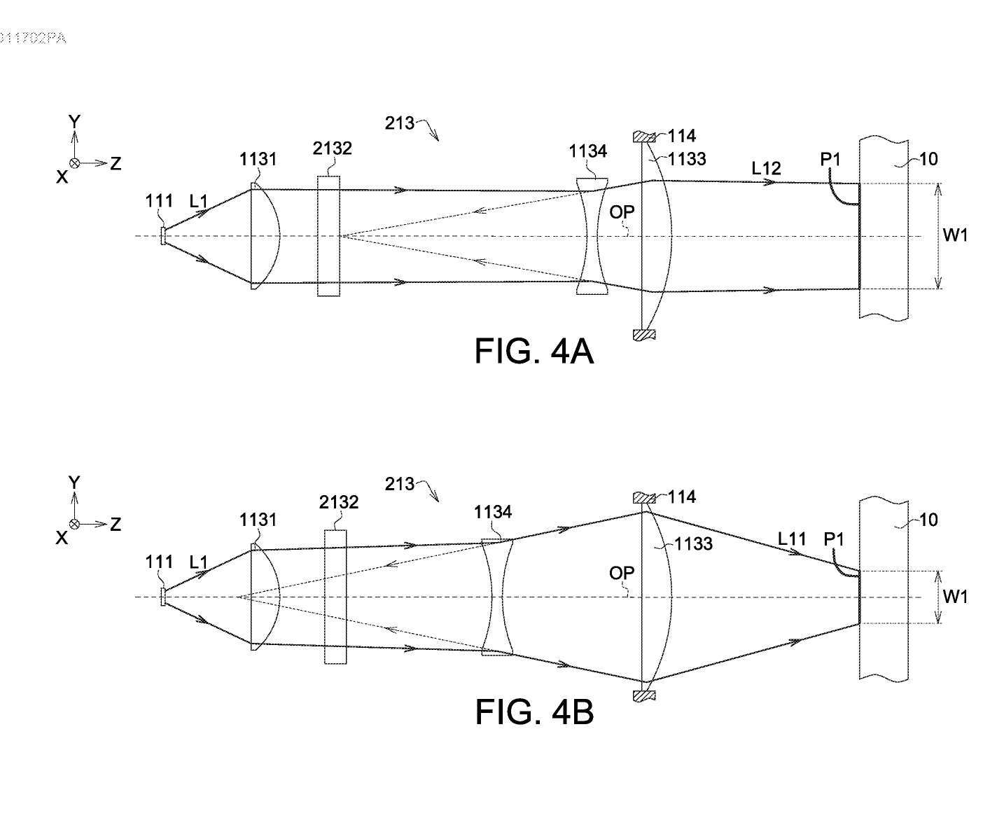

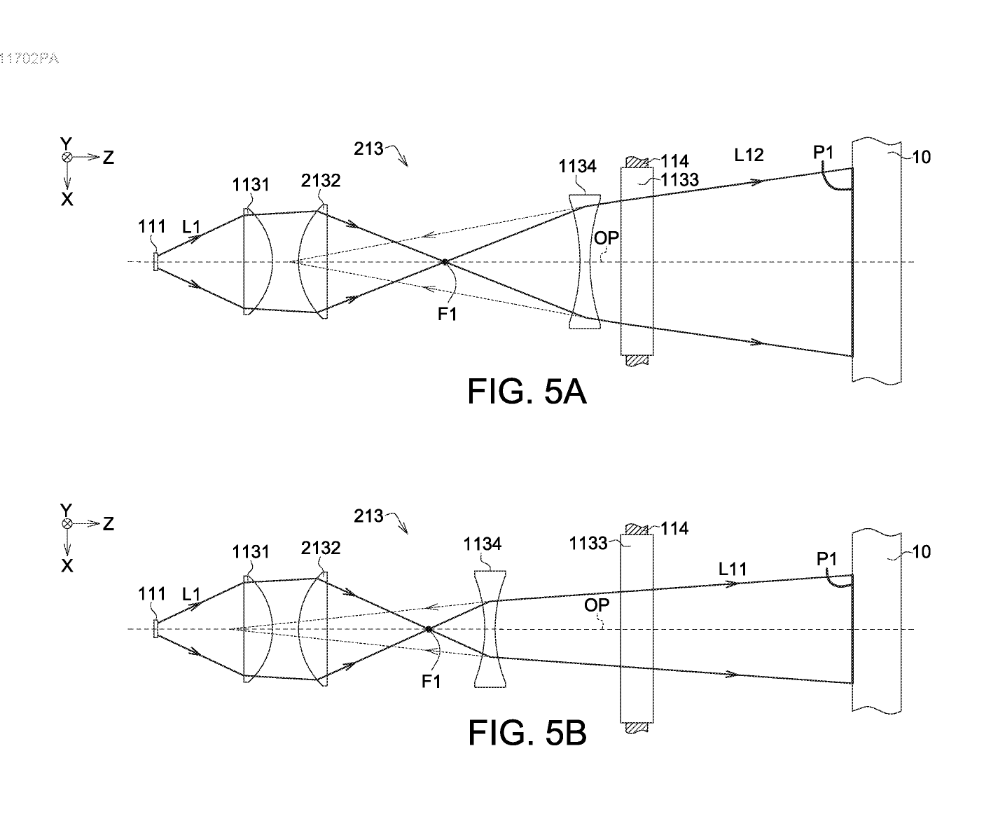

FIG. 4A illustrates a top view of the lens group 213 according to another embodiment of the disclosure, FIG. 4B illustrates a top view of the concave lens 1134 of FIG. 4A moving to another position, FIG. 5A illustrates a side view of the lens group 213 of FIG. 4A, and FIG. 5B illustrates a side view of the lens group 213 of FIG. 4B.

The lens group 213 having a common optical axis includes the first convex lens 1131, a second convex lens 2132, the cylindrical convex lens 1133 and the concave lens 1134 which are arranged sequentially. In the present embodiment, the second convex lens 2132 is a first cylindrical convex lens, and the cylindrical convex lens 1133 is a second cylindrical convex lens. In addition, the second convex lens 2132 is disposed in way of a long axis of the second convex lens 2132 being parallel to Y axis, and the cylindrical convex lens 1133 is disposed in way of a long axis of the cylindrical convex lens 1133 being parallel to X axis substantially perpendicular to Y axis.

In addition, the focal length of the concave lens 1134 is at least negative twice that of the second convex lens 2132, and the focal length of the cylindrical convex lens 1133 is longer than that of the concave lens 1134.

Under the arrangement of the first convex lens 1131, the second convex lens 2132, the cylindrical convex lens 1133 and the concave lens 1134, the light L1 can be transformed into the second-type light L12 in the second mode which is collimated rectangular shaped light.

In addition, the concave lens 1134 may move along the common optical axis between the second convex lens 2132 and the cylindrical convex lens 1133 for adjusting the irradiance and a width W1 of an illuminated area P1 of the second-type light L12 in the second mode on the object 10.

As shown in FIG. 4B, the concave lens 1134 is controlled to move along the optical axis OP between an image focal point (not illustrated) of the second convex lens 2132 and the cylindrical convex lens 1133 for adjusting the width W1 of the illuminated area P1 of the first-type light L11 in the first mode on the object 10. The concave lens 1134 approaches the cylindrical convex lens 1133, and accordingly the width W1 of the illuminated area P1 becomes smaller, but the first-type light L11 in the first mode becomes brighter for detecting the defect of the object 10.

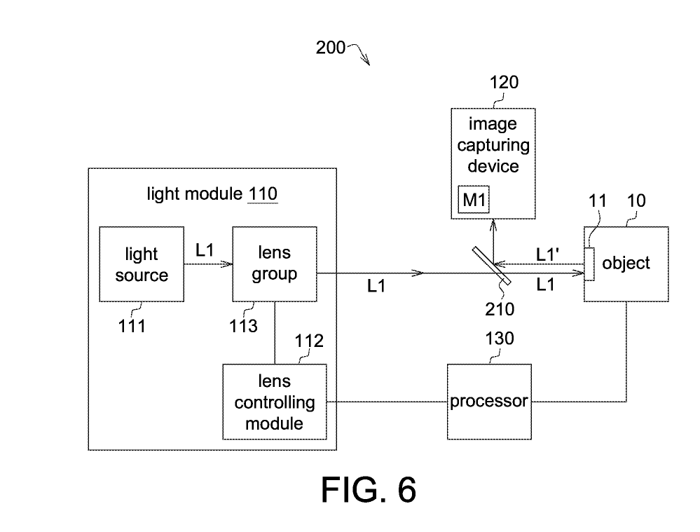

FIG. 6 illustrates a block diagram of an optical inspection system 200 according to another embodiment of the disclosure. The optical inspection system 200 includes the light module 110, the image capturing device 120, the processor 130 and a beam splitter 210.

The beam splitter 210 is disposed between the light module 110 and the object 10 to reflect the light L1′ reflected by the object 10 to the image capturing device 120.

Furthermore, the light L1 emitted from the light module 110 may pass through the beam splitter 210 and then is incident to the object 10. The light L1 incident to the object 10 is reflected back the beam splitter 210 and then is reflected to the image capturing device 120. As a result, the light L1 incident to the object 10 and the light L1′ reflected to the object 10 are substantially coaxial, such that the image of the defect 11 captured by the image capturing device 120 may be clearer and has high sharpness, and accordingly the measured size of the defect 11 may be more accurate.

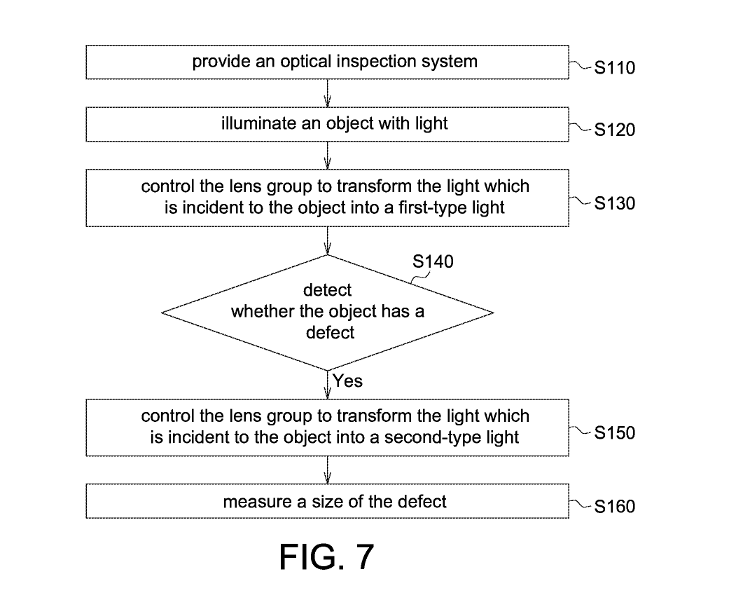

FIG. 7 illustrates a flow chart of an optical inspection method according to an embodiment of the disclosure.

In step S110, the optical inspection system 100 is provided. The optical inspection system 100 includes the light module 110, the image capturing device 120 and the processor 130. In another embodiment, the optical inspection system 100 may be replaced by the optical inspection system 200.

The light module 110 includes the light source 111, the lens controlling module 112 and the lens group 113. The light source 111 may emit the light L1. The lens controlling module 112 may adjust the lens group 113 to transform the light L1 which is incident to the object 10 into the collimated rectangular shaped light, the collimated rectangular shaped light may be the first-type light L11 in the first mode or the second-type light L12 in the second mode. The second-type light L12 is different from the first-type light L11.

In step S120, the light source 111 emits the light L1 to the object 10 through the lens group 113.

In step S130, the lens controlling module 112 switches the lens group 113 to the first mode for transforming the light L1 which is incident to the object 10 into the first-type light L11 for detecting the defect 11 of the object 10.

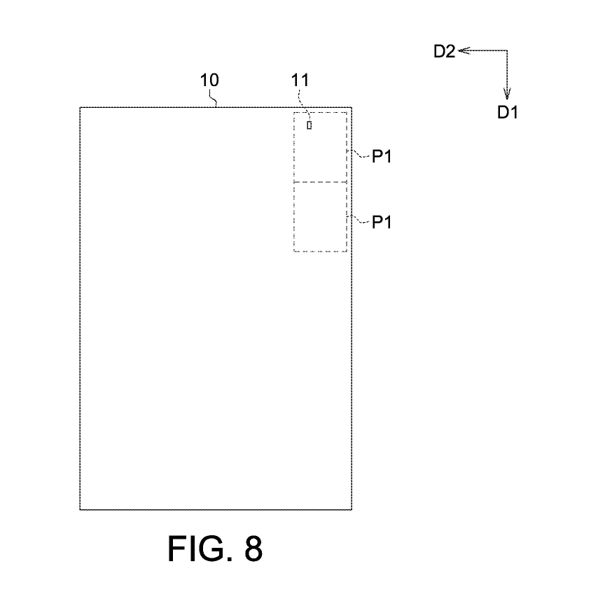

FIG. 8 illustrates a diagram of the object 10 of FIG. 3A.The object 10 may have at least one defect 11. The first-type light L11 in the first mode is incident to the object 10 and forms the illuminated area P1 on the object 10. The image M1 of the illuminated area P1 may be captured by the image capturing device 120.

In step S140, the processor 130 may detect whether the object 10 has the defect 11 from the image M1 using any image analysis technique. If the defect 11 is detected by the processor 130, the step proceeds to step S150. If no defect 11 is detected by the processor 130, the first-type light L11 in the first mode may move to another region along a direction, such as a first direction D1, a second direction D2 vertical to the first direction D1 or another direction.

In step S150, the lens controlling module 112 may adjust the lens group 113 to transform the light L1 which is incident to the object 10 into the second-type light L12 in the second mode for measuring the size of the defect 11.

In step S160, the processor 130 measures the size of the defect 11 from the image M1 using any image analysis technique.

In one embodiment, after the entire object 10 is scanned by the first-type light L11 in the first mode, the processor 130 starts to measure the sizes of all detected defects 11 through the second-type light L12 in the second mode. In another embodiment, once one or some defect 11 is detected before the entire object 10 is scanned by the first-type light L11 in the first mode, the processor 130 starts to measure the size of the detected defect 11 through the second-type light L12 in the second mode.

It will be clear that various modifications and variations can be made to the disclosed embodiments. It is intended that the specification and examples be considered as exemplary only, with a true scope of the disclosure being indicated by the following claims and their equivalents.

What is claimed is:

1. An optical inspection system, comprising:
a light source configured to illuminate an object with a light;
a lens group configured to project the light from the light source as a collimated rectangular shaped light; and
a lens controlling module, configured to switch the lens group for changing an irradiance of the collimated rectangular shaped light and adjusting an illuminated area of the collimated rectangular shaped light on an object surface of the object.

2. The optical inspection system according to claim 1, wherein the lens group is disposed along a common optical axis, the lens group comprising:
a first convex lens, configured to collimate the light from light source;
a second convex lens;
a concave lens; and
a cylindrical convex lens;
wherein the concave lens is disposed between the second convex lens and the cylindrical convex lens, and the concave lens is moveable along the common optical axis.

3. The optical inspection system according to claim 2, wherein the concave lens is controlled by the lens controlling module to move to a position between the second convex lens and the cylindrical convex lens for changing the irradiance and the illuminated area on the object surface.

4. The optical inspection system according to claim 1, wherein the lens group is configured to switch between a first mode and a second mode, the collimated rectangular shaped light is transformed to a first-type light in the first mode and transformed to a second-type light in the second mode, the optical inspection system further comprising:
an image capturing device configured to capture an image of the object; and
a processor configured to detect whether the object has a defect from the image in the first mode and measure a size of the defect from the image in the second mode;
wherein the first-type light has higher irradiance than the second-type light.

5. The optical inspection system according to claim 1, further comprising:
a beam splitter, disposed between the light source and the object for reflecting the light reflected by the object to an image capturing device.

6. The optical inspection system according to claim 2, wherein the second convex lens is a first cylindrical convex lens having a long axis, the cylindrical convex lens is a second cylindrical convex lens having a long axis, and the long axis of the first cylindrical convex lens is perpendicular to the long axis of the second cylindrical convex lens.

7. The optical inspection system according to claim 2, wherein the second convex lens is a first cylindrical convex lens, and a focal length of the concave lens is at least negative twice that of the first cylindrical convex lens.

8. The optical inspection system according to claim 2, wherein the cylindrical convex lens is a second cylindrical convex lens, and a focal length of the second cylindrical convex lens is longer than that of the concave lens.

9. The optical inspection system according to claim 2, wherein the second convex lens is a first cylindrical convex lens, the cylindrical convex lens is a second cylindrical convex lens, and the concave lens is movably disposed between an image focal point of the first cylindrical convex lens and the second cylindrical convex lens.

10. An optical inspection method, comprising:
providing the optical inspection system according to claim 1;
illuminating the object with light of the light source; and
switching the lens group by the lens controlling module to transform the light into the collimated rectangular shaped light which is incident to the object, wherein the irradiance and the illuminated area of the collimated rectangular shaped light on the object surface is adjusted by the lens controlling module.

11. The optical inspection method according to claim 10, wherein the lens group is configured to switch between a first mode and a second mode, the collimated rectangular shaped light which is transformed into a first-type light in the first mode and transformed into a second-type light in the second mode, and the optical inspection method further comprising:
capturing an image of the object in the first mode;
detecting whether the object has a defect from the image;
switching the lens group to the second mode when the defect of the object is detected; and
measuring a size of the defect from the image;
wherein the first-type light has higher irradiance than the second-type light.
